(19) United States
(12) Patent Application Publication
(10) Pub. No.: US 2019/0035267 A1
(43) Pub. Date: Jan. 31, 2019

(54) AUTOMATED CONTROL OF TRAFFIC DEVICES WITH VEHICLES

(71) Applicant: MICROSOFT TECHNOLOGY LICENSING, LLC, Redmond, WA (US)

(72) Inventors: Andreas BALZER, Dublin (IE); Muiris WOULFE, Dublin (IE); Alan MULHALL, Dublin (IE)

(21) Appl. No.: 15/661,872

(22) Filed: Jul. 27, 2017

(51) Int. Cl. G08G 1/07; G08G 1/01

(52) U.S. Cl. CPC G08G 1/07; G08G 1/0145

(57) ABSTRACT

The present disclosure provides a number of techniques for automation of traffic control devices with vehicles. A centralized traffic control server can identify vehicles, establish priority levels for vehicles, and control the states of traffic control devices to prioritize travel of the vehicles. The identification can be based on visual information or electronically transmitted information. Furthermore, the centralized traffic control server can use organizational data and event data to help determine a priority for occupants of particular vehicles. Finally, distributed traffic control servers based on intersections or groupings of intersections can be deployed to automate control of individual traffic control devices at each traffic intersection.

### BACKGROUND

Visual traffic signals, such as traffic lights, are vital for managing traffic to reduce vehicular accidents and coordinate traffic flow. However, visual traffic signals lead to many inefficiencies with vehicles often being required to stop even when doing so provides no benefit to traffic flow. This consequently leads to adverse environmental impacts such as increased fuel consumption and other adverse consequences impacting commerce, e.g., increased travel time and shipping costs. In addition, existing systems are limited in that they cannot coordinate with other computing systems or distinguish or identify individual drivers. With these shortcomings, traffic systems can be inefficient, or even incapable, in coordinating priorities between individual drivers.

It is with respect to these and other considerations that the disclosure made herein is presented.

### SUMMARY

The techniques disclosed herein provide an efficient traffic control system that facilitates automated control of traffic devices with vehicles. This disclosure describes systems, methods, user interfaces, and computer-readable media for automated control of visual traffic control devices and non-visual traffic control devices. Among many other benefits, the techniques disclosed herein can automatically control traffic devices to more effectively and efficiently coordinate vehicles through traffic. In some configurations, organizational data indicating a priority level associated with a user or an event can be used to control a state of a traffic control signal. Thus, in some embodiments, a traffic control signal can dynamically control the flow of some vehicles based on priorities associated with occupants of some vehicles. Traffic flow and the efficiency of moving vehicles can then be more coordinated with other systems and thus utilize a range of priorities of computer users and vehicle occupants. By increasing the efficiency of moving vehicles through traffic, numerous other benefits including increased fuel efficiency and decreased travel time can be realized.

According to at least one implementation, a method of automated control of traffic devices can include an operation of identifying a vehicle by at least one vehicle identifier. For example, the vehicle identifier can include a unique identifier such as a Vehicle Identification Number, license plate information, or other identifiers. In one aspect, other identifiers can include electronic signals transmitted from a vehicle, specific indicia or paint schemes, symbols (e.g., on a roof or upper surface of a vehicle), specific heat signature, and/or specific audio signature. Other forms of identifiers are also applicable to some implementations. Heat signatures can indicate a number of passengers of a vehicle. As described herein, identifiers, which may include an indication of a number of passengers, can be used to determine a location or the proximity of a vehicle and/or control the state of one or more traffic devices. For illustrative purposes, a vehicle can be identified by an active mechanism, e.g., a signal generated by the vehicle, or a vehicle can be identified by a passive mechanism, e.g., a camera of the system 100 identifying a property, heat signature, or an indicia or paint scheme of a vehicle.

The method can further include an operation of receiving organizational data indicating a priority level associated with a user identity. The organizational data can include information related to a status of a user or a priority level associated with a user. Additionally, the user identity can be associated with the vehicle identifier. Data making such an association can indicate that the user associated with the user identity can be an occupant of the vehicle. Furthermore, the organizational data can define a calendar event associated with the user identity. In this example, the priority level is based on at least one of a category of the calendar event, a number of attendees of the calendar event, a role associated with the occupant, a length of the calendar event, or a rank of an attendee of the calendar event. The priority level can be based on these and other calendar event attributes.

The method can also include controlling a state of a visual traffic control signal based on the priority level. Generally, the state of the visual traffic control signal operates to control a flow of traffic around the vehicle. Thus, through intelligent control of the visual traffic control signal, a more efficient direction of traffic can be achieved, thereby minimizing or reducing travel time for the occupant(s) of the vehicle based on the established priority level. Additionally, according to some aspects, journey times or transit times for other vehicles may be sacrificed (e.g., by sending them into a traffic jam while keeping a higher priority vehicle on clear roadways) such that a priority occupant or object experiences a reduced transit or journey time.

According to another implementation, a system of traffic control and routing can include a first visual traffic control signal, a second visual traffic control signal, and a traffic control server in operative communication with the first visual traffic control signal and the second visual traffic control signal. Additionally, according to one implementation, a mesh or distributed grid of smart traffic control signals may be deployed, where the individual traffic control signals communicate with one another. In this example, the individual traffic control signals may be termed traffic control servers.

In this example, the traffic control server can be configured to perform a method that includes identifying a vehicle by at least one vehicle identifier and receiving organizational data indicating a priority level associated with a user identity. The user identity can be associated with an occupant of the vehicle. Additionally, the organizational data can define a calendar event having one or more attributes, the calendar event is associated with the user identity, and the priority level can be based on the one or more attributes.

The method can also include controlling a state of the first visual traffic control signal based on the priority level. For example, the state of the first visual traffic control signal can control a directional flow of traffic traveling in the same direction as the vehicle.

Furthermore, the method can include controlling a state of the second visual traffic control signal based on the priority level. In this example, the state of the second visual traffic control signal can stop or slow a flow of traffic that is not travelling in the direction of the vehicle. Thus, in this manner, the system of traffic control can efficiently route traffic based on the priority level and other factors, thereby reducing congestion and improving a vehicular occupant's experience.

According to yet another implementation, a method of automated control of traffic devices can include electronically identifying a vehicle by at least one vehicle identifier. For example, the vehicle identifier can include any suitable vehicle identifier, including a Vehicle Identification Number, license plate information, or other identifiers. The method can identify a vehicle by the use of one or more suitable technologies including cameras, wireless sensors, and other suitable optical sensors.

The method can also include receiving organizational data indicating a priority level associated with a user identity and an anticipated route for the vehicle. Generally, the user identity can be associated with an occupant of the vehicle. Furthermore, the organizational data can define a calendar event having one or more attributes and the priority level can be based on the one or more attributes. Subsequently, the method includes controlling a state of at least one traffic control device based on the priority level. In this example, the state of the at least one traffic control device can at least partially control a flow of traffic on the anticipated route. By associating priority levels with occupants of a vehicle, the techniques disclosed herein can give one or more vehicle occupants priority in traffic. The occupants may be temporarily associated with the vehicle (e.g., occupants in a taxi, bus, rental vehicle, ride share vehicle, or other mode of transport) or may be owners/users particularly associated with a vehicle. Among other benefits and features disclosed herein, occupants of a vehicle can be prioritized based on a level within an organization, a priority of a meeting, a priority of a task they are to perform, and/or other factors.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a diagram illustrating an example operating environment in which one or more traffic control servers can operate to facilitate automated control of traffic devices.

FIG. 2 is a diagram illustrating an example scenario in which one or more vehicles approach an automated intersection.

FIG. 3 is a diagram illustrating an example scenario in which one or more vehicles negotiate an automated intersection.

FIG. 4A is an overhead view of an example scenario in which one or more vehicles negotiate an automated intersection.

FIG. 4B is an overhead view of an example scenario in which a vehicle is given priority over other vehicles to negotiate an intersection.

FIG. 4C is an overhead view of an example scenario in which a vehicle is given priority over another vehicle to negotiate an intersection.

FIG. 5A is an overhead view of an example scenario in which one or more vehicles negotiate different intersections.

FIG. 5B is an overhead view of an example scenario in which a vehicle is given a prioritized route over other vehicles.

FIG. 5C is an overhead view of an example scenario in which vehicles are directed to cross a previously prioritized route.

FIG. 6 is a flow diagram of a method of automated control of traffic devices with vehicles, according to the techniques and technologies disclosed herein.

FIG. 7 is a computer architecture diagram illustrating a computing device architecture for a vehicle or computing device capable of implementing aspects of the techniques and technologies presented herein.

### DETAILED DESCRIPTION

The techniques disclosed herein provide an efficient traffic control system that facilitates automated control of traffic devices with vehicles. This disclosure describes systems, methods, user interfaces, and computer-readable media for automated control of visual traffic control devices and non-visual traffic control devices. Among many other benefits, the techniques disclosed herein can automatically control traffic devices to more effectively and efficiently move vehicles through traffic. By increasing the efficiency of moving vehicles through traffic, numerous other benefits including increased fuel efficiency and decreased travel time are realized.

According to at least one implementation, a method of automated control of traffic devices can include identifying a vehicle by at least one vehicle identifier. For example, the vehicle identifier can include a unique identifier such as a Vehicle Identification Number, license plate information, or other identifiers. In one aspect, other identifiers can include electronic signals transmitted from a vehicle, specific indicia or paint schemes, symbols (e.g., on a roof or upper surface of a vehicle), specific heat signature, and/or specific audio signature. Other forms of identifiers, such as ones that utilize decals, are also applicable to some implementations.

The method can further include receiving organizational data indicating a priority level associated with a user identity. The organizational data can include information related to a status of a user or a priority level associated with a user. Additionally, the user identity can be associated with an occupant of the vehicle. The occupants may be temporarily associated with the vehicle (e.g., occupants in a taxi, bus, rental vehicle, ride share vehicle, or other mode of transport) or may be owners/users particularly associated with a vehicle.

The method can also include controlling a state of a visual traffic control signal based on the priority level. Generally, the state of the visual traffic control signal controls a flow of traffic encompassing the vehicle. Thus, through intelligent control of the visual traffic control signal, a more efficient direction of traffic can be achieved, thereby minimizing or reducing travel time for the occupant(s) of the vehicle based on the established priority level. Additionally, according to some aspects, journey times or transit times for other vehicles may be sacrificed (e.g., by sending them into a traffic jam while keeping a higher priority vehicle on clear roadways) such that a priority occupant or object experiences a reduced transit or journey time.

According to another implementation, a system of traffic control and routing can include a first visual traffic control signal, a second visual traffic control signal, and a traffic control server in operative communication with the first visual traffic control signal and the second visual traffic control signal. Additionally, according to one implementation, a mesh or distributed grid of smart traffic control signals may be deployed, where the individual traffic control signals communicate with one another. In this example, the individual traffic control signals may be termed traffic control servers.

In this example, the traffic control server can be configured to perform a method that includes identifying a vehicle by at least one vehicle identifier and receiving organizational data indicating a priority level associated with a user identity. The user identity can be associated with an occupant of the vehicle. The occupants may be temporarily associated with the vehicle (e.g., occupants in a taxi, bus, rental vehicle, ride share vehicle, or other mode of transport) or may be owners/users particularly associated with a vehicle. Temporary associations can be made through any suitable source, such as data that can be generated by tracking the user's mobile phone, or the user account they sign into for the taxi/ride share, an Uber account, a bus ticket, an event ticket, etc.

The method can also include controlling a state of the first visual traffic control signal based on the priority level. For example, the state of the first visual traffic control signal can control a flow of vehicular traffic travelling in the same direction as the vehicle.

Furthermore, the method can include controlling a state of the second visual traffic control signal based on the priority level. In this example, the state of the second visual traffic control signal can stop or cease an opposing flow of vehicular traffic travelling in the opposite direction from the vehicle. Thus, in this manner, the system of traffic control can efficiently route traffic based on the priority level and other factors, thereby reducing congestion and improving a vehicular occupant's experience. Other benefits can include improved fuel economy, reduced emissions, improved timing of arrival of priority occupants, improved routing of emergency response vehicles, reduced traffic congestion, and reduced traffic incidents in general.

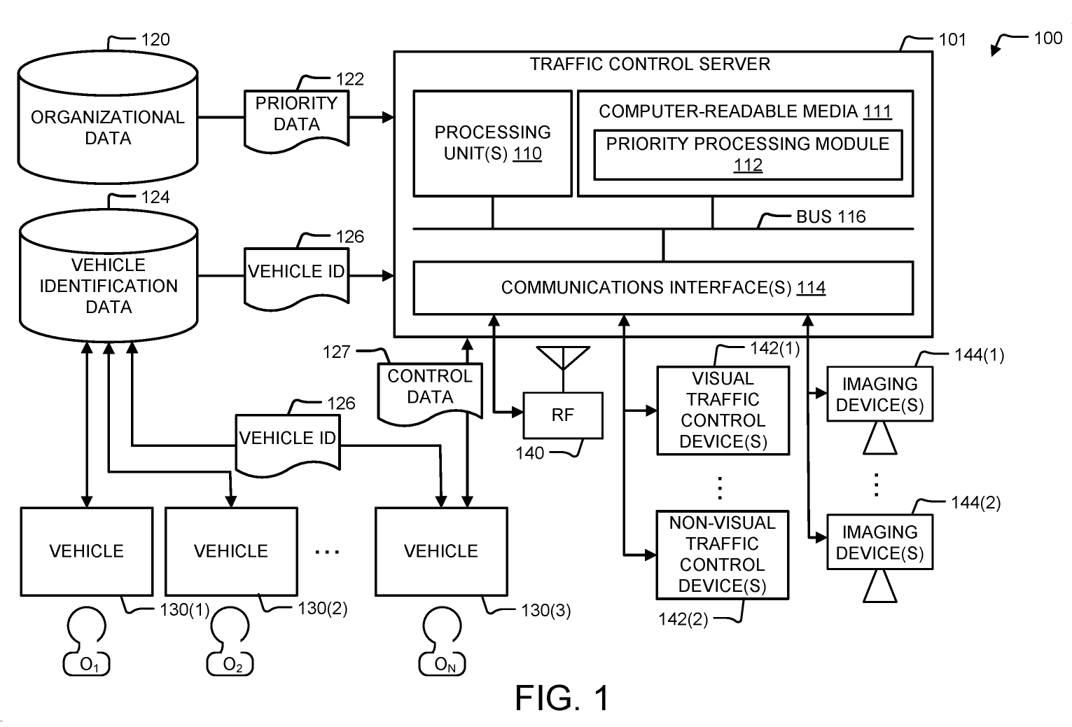

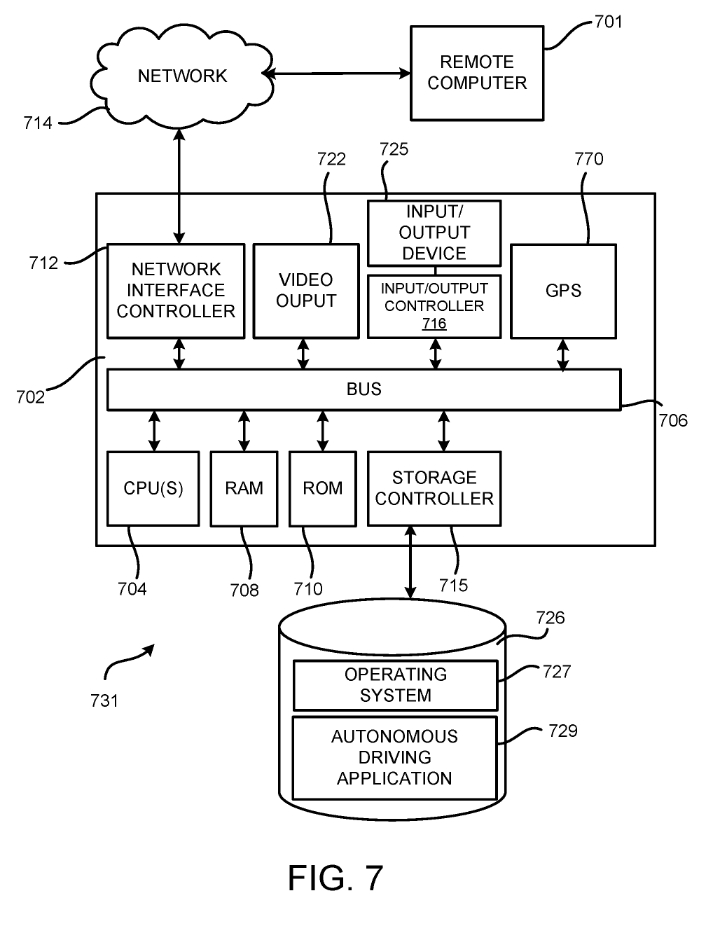

Turning now to the drawings, FIG. 1 is a diagram illustrating an example operating environment of a system 100 to facilitate automated control of traffic devices. The system 100 includes a traffic control server 101 configured to control the various states of traffic control devices thereby controlling a flow or flows of traffic. The traffic control server 101 may be a computing device arranged to communicate or directly control the various states. For example, the traffic control server 101 can comprise: one or more processing units 110 configured to process data; computer readable storage media 111 in communication with the processing units 110 over bus 116 configured to store data; and one or more communication interfaces 114 configured to distribute control signals and receive information. The traffic control server 101 can also comprise a priority processing module 112 configured to execute on the processing units 110 and direct the processing units 110 to perform computer-implemented methods of automated control of traffic devices. A more detailed description of particular components related to the traffic control server 101 and other suitable computing devices, including autonomous vehicle control systems, is provided below with reference to FIG. 7.

As shown in FIG. 1, the traffic control server 101 is in communication with organizational data store 120. The organizational data store 120 is configured to store contextual data related to one or more user identities. For example, the organizational data store 120 can store and transmit priority data 122 for the traffic control server 101. The priority data 122 can include any suitable information and data related to user identities, including but not limited to, user identity (User ID), organizational structure, organizational hierarchy, organizational charts, calendar data, event timing data, meeting data, and other data useful in determining priority associated with an occupant of a vehicle.

Calendar data can define appointments and other aspects of a schedule. Thus, in the techniques disclosed herein, a system can determine a priority of a vehicle or an occupant of the vehicle based on an event or appointment of one or more users. Priority data can be associated with an appointment or people associated with an appointment.

The priority data 122 can also be based on a hierarchy, such as a government, educational, and/or company organizational chart. For example, a government organizational chart may include information for varying levels of government officials. Similarly, a company organizational chart may include information related to particular levels of employees. Moreover, an educational organizational chart, such as for a university, may include a hierarchy of president, lecturers, postgrad students, undergrad students, etc. Individuals can be individually associated with a priority or groups of individuals can be associated with a priority. Thus, as will be described in more detail below, some examples of a traffic control system can prioritize the flow of traffic based on a person's schedule and/or a priority associated with a person's schedule. In another example, if an appointment includes the president of a company, and the president is an occupant of a vehicle, traffic flow for that vehicle may be prioritized over other vehicles. In some cases, a system can control a priority level associated with all attendees of such a meeting, thus giving such users a certain priority over other vehicles on the road.

Additionally, in other cases, the traffic control server 101 can use multiple elements to make a decision for prioritizing vehicle travel based on the priority data 122. For instance, the president of the company might normally get priority, but a meeting a few minutes away where a low-ranking employee is the facilitator might result in that low-ranking employee being prioritized. Furthermore, the priority data 122 may be configurable allowing overrides in emergencies or other situations. The traffic control server 101 may then subsequently determine how to prioritize travel for particular vehicles while taking into consideration any such overrides, configurable priorities, and other attributes.

In one illustrative example, traffic signals can be connected to calendar systems, such as those provided by Gmail, iCloud, and Microsoft Outlook. This can be achieved by having one or more users pre-registering their vehicles and providing access to their calendar through some management system, which could be provided as a website. Furthermore, users could register license plate information or other vehicle IDs within a traffic control system or Human Resources system such that the system can automatically correlate the vehicle ID with an organizational calendar. In some embodiments, such data can be obtained by a vehicle from the user's mobile phone through Bluetooth, Wi-Fi, USB or any other suitable means. If the user has a meeting or is running late for work, priority access can be provided at one or more traffic control signals. This can be particularly useful for traffic lights on business campuses, university campuses, etc. In some configurations, a system could consider a number of factors, including but not limited to: the author of the calendar invite, priority of the calendar invite, categories of the calendar invite, number of attendees, whether the user is the organizer of the meeting, whether the meeting is recurring (as recurring meetings can be less important than non-recurring meetings), the rank of attendees at the meeting, a length of time until a meeting commences relative to a distance left for an occupant to travel, etc. For illustrative purposes, a calendar invite is also referred to herein as a calendar event. Additionally, according to one example, an additional factor may include access control lists for calendar invites and other attributes. Such factors can be referred to herein as calendar event attributes. Such factors and other factors can be used to determine which user and/or vehicle receives the highest priority. Such embodiments can also be applied to public traffic signals.

In one illustrative example, a calendar event can be associated with the number of attendees of the appointment. For example, if an executive is presenting to a large number of employees, calendar data defining this appointment can have an associated priority. Such an appointment can be prioritized relative to, higher or lower, other appointments involving executives at a similar level attending an appointment having a smaller number of attendees.

In another illustrative example, a calendar event attribute can define an access control list associated with a calendar event. Generally, an access control list defines an access level for allowing users for viewing, editing, sharing, and/or otherwise manipulating a calendar event. Such access levels can include, for example, editing rights, sharing rights, reviewing rights, and other similar access levels. With regard to priority levels, a user with editing rights to a shared calendar or a calendar event may have a lower or higher priority than a user with reviewing rights to the same calendar event.

According to yet another illustrative example, priority levels may be based on any of the aforementioned calendar attributes. For example, calendar attributes can include a category of the calendar event, a number of attendees of the calendar event, a role associated with the occupant, a length of the calendar event, or a rank of an attendee of the calendar event. A category of the calendar event may establish a priority level that is higher or lower than other calendar events if, for example, the calendar event is marked “urgent” or “high importance.” Furthermore, a calendar event with a relatively large number of attendees may be deemed to have a higher or lower priority than a calendar event with less attendees. In addition, users associated with a calendar event with a shorter time duration can be prioritize higher or lower than users associated with a calendar event with a longer time duration.

Additionally, a role of a vehicle occupant in a calendar event can also affect priority. For example, an occupant who is a presenter or organizer may have a higher of lower priority than another occupant or vehicle that is an attendee of a calendar event. The role can also include one or more tasks to be completed by the attendee at the calendar event. Accordingly, an attendee with a number of tasks to be completed may have a higher or lower priority than another attendee with less tasks to be completed. Somewhat similarly, a rank of an attendee of a calendar event may alter priority levels when compared to the ranks of other attendees of a calendar event. Furthermore, other attributes including a length of a calendar event may alter priority levels. For example, a calendar event with a longer duration than a second calendar event may have higher or lower priority.

In another example, a category of the calendar event can be used alone or in conjunction with other calendar event attributes. For example, a calendar event can be open attendance or invitation-only. A category of the calendar event can be based on associated tasks. For example, a meeting may be related to business-critical tasks, such as tax reporting, and another meeting may be related to social events. A priority of a user or a vehicle can be based on such categories.

The techniques can also apply to zones having a selected set of traffic control signals. For example, zones such as a business campus or a university campus can have a select set of traffic lights that can also assign priority based on a user's rank within an organization or the amount of time they have worked there. For instance, the CEO could get priority access, particularly if they are running late for a meeting. Additionally, traffic signs and lights can be changed based on whether students approaching in their cars have exams. Users can be prioritized, predetermined users based on one or more factors, including a position, a subscription defining a priority level, a government position, etc. Thus, a type of meeting can also be used to determine a priority level of a vehicle or user.

The aforementioned examples can be extended to public traffic signals with, e.g. presidents, other politicians or high-ranking businesspeople getting priority access. This could save policing costs as in many cities, police are used to ensure priority access for such government officials.

Any combination of factors can be utilized to determine a priority of the vehicle and/or a priority of an occupant. As described herein, a priority can be associated directly with a vehicle or an occupant. In addition, a priority can be associated with the calendar event, e.g., an appointment, or other data received by the system 100. In some configurations, a priority can be based on whether the vehicle is an autonomous or a non-autonomous vehicle. In some scenarios, an autonomous can be prioritized over a non-autonomous vehicle. In other scenarios, a non-autonomous can be prioritized over an autonomous vehicle. In some configurations, when combinations of factors are used, certain factors, such as a priority provided by a calendar event or a title of an individual, and a vehicle type, can be weighted. Thus, an overall priority value can be associated with a particular vehicle using a number of weighted factors. In some configurations, the weighting associated with individual factors can be dynamically changed over time.

This system can also be used to interact with other traffic signage. For instance, speed limits could be increased or reduced based on vehicle type. In addition, stop signs could be disabled where it is determined that stopping provides no advantage. Other signs could also be modified as desired. To enable this, the techniques disclosed herein can use signs implemented as LED panels with the LEDs used to control the messaging. Other dynamic messaging technologies, e.g. e-ink, LCD panels, plasma displays, variable message signs, speakers, and other suitable devices can be used.

Returning to FIG. 1, the traffic control server 101 can also be in communication with a vehicle identification data store 124. The vehicle identification data store 124 is configured to store vehicle identifiers 126 received from one or more vehicles 130. For example, the vehicle identification data store 124 can store and transmit vehicle ID 126 for the traffic control server 101. As used herein, a vehicle identifier or vehicle ID can refer to any unique identifier useful in identifying a particular vehicle. The vehicle ID 126 may be associated with a particular non-autonomous vehicle or autonomous vehicle, and may be provided to the vehicle identification data store 124 in some implementations. The vehicle ID 126 may be shared with the traffic control server 101. In one aspect, the vehicle ID 126 can include a unique identifier such as a Vehicle Identification Number, license plate information, electronic signals transmitted from a vehicle, specific indicia or paint schemes, symbols (e.g., on a roof or upper surface of a vehicle), specific heat signature, and/or specific audio signature. In another aspect, the vehicle ID 126 can include a vehicle digital identifier. The vehicle digital identifier can include a SIM card ID, ESN, MEID, IMEI or other identifier associated with a wireless communication device onboard the vehicle. Such wireless communication devices can include wireless telephony devices, cellular telephones (e.g., by a phone number), cellular communications systems, digital communications systems, satellite communications systems, or any other electronic device associated with or onboard the vehicle. An onboard system can include an after-market device such as one provided by OnStar. Other forms of identifiers are also applicable to some implementations. Heat signatures observed from a camera of the system 100 can indicate a number of passengers of a vehicle. As will be described herein, identifiers, which may include an indication of a number of passengers, can be used to determine a location or the proximity of a vehicle and control the state of one or more traffic devices.

As further illustrated in FIG. 1, a plurality of users or occupants O₁, O₂, through O_{N} are associated with a plurality of vehicles 130(1), 130(2), through 130(3), respectively. As shown, the occupants O₁, O₂, through O_{N} utilize or occupy the vehicles 130(1), 130(2), through 130(3) while the vehicles 130(1), 130(2), through 130(3) traverse roadways with traffic devices controlled by the traffic control server 101. It should be understood that although described as occupants, the occupants O₁, O₂, through O_{N} can also refer to objects, such as parcels for delivery or packages reaching a particular destination. In at least one implementation, the vehicles 130(1), 130(2), through 130(3) may be autonomous vehicles. According to other aspects, the vehicles 130(1), 130(2), through 130(1) may be non-autonomous vehicles. For example, hardware and computer system components capable of at least partially controlling an autonomous vehicle are described more fully below with reference to FIG. 7. In this example, control data 127 representing states of various traffic control devices may be transmitted directly to any of vehicles 130(1), 130(2), through 130(3) for use by the vehicle. The control data 127 can be received and processed by the vehicle to control the speed and/or the direction of the vehicle. In some configurations, the control data 127 can comprise directions to be displayed or otherwise communicated to a user. For example, directions can be communicated to a user on a graphical user interface within the vehicle, an automated voice comprising the directions can be communicated to the user via a speaker system, a tactile system, etc. Additionally, although not particularly illustrated, it should be understood that the vehicles 130(1), 130(2), through 130(3) may comprise any typical component associated with an autonomous or non-autonomous vehicle, including, but not limited to, indicia indicating a Vehicle Identification Number (VIN), a license plate number, a vehicle registration number, and other such vehicular identifiers. Furthermore, the vehicles 130(1), 130(2), through 130(3) can also contain numerous mechanical components including braking systems, drive train systems, propulsion systems, control systems, and other components typical in autonomous and non-autonomous vehicles. Accordingly, any of the vehicles 130(1), 130(2), through 130(3) may include any typical automotive mechanical component without departing from the scope of this disclosure.

The system 100 further includes wireless communications components 140 in communication with the traffic control server 101. The wireless communications components 140 can include wireless transceivers, receivers, transmitters, and other components configured to transmit/receive information wirelessly. For example, the wireless communications components 140 can include cellular communications components, radio frequency identifier components, wireless networking components, and other suitable components. The wireless communications components 140 can wirelessly receive vehicle ID 126 in some implementations. The wireless communications components 140 may be embedded in a traffic control devices and/or roadways, positioned near or adjacent to roadways, or may be otherwise distributed to allow effective communication between vehicles and the traffic control server 101. Additionally, the wireless communications components 140 can receive data indicating locations, routes, and telemetry for one or more of the vehicles 130(1), 130(2), through 130(3).

The system 100 further includes visual vehicular traffic control devices 142(1) and non-visual vehicular traffic control devices 142(2). Traffic control devices 142 are also referred to herein as “traffic devices 142.” In general, a visual vehicular traffic control device is a traffic control device that visually presents information to direct a flow of or control vehicular traffic. For example, visual vehicular traffic control devices can include electronic signage configured to display indicia, such as speed limits or traffic data. Visual vehicular traffic control devices can also include electronic signage configured to display representations of typical traffic control signs, such as yield and stop signs. Additionally, visual vehicular traffic control devices can include traffic lights, flashing lights, and other suitable lights. Visual vehicular traffic control devices can also include warning signs, such as crosswinds, slippery road surface, falling rocks, or any other suitable warning sign. It should be understood that the visual vehicular traffic control devices 142(1) may be configured to change states to any of a plurality of visual states depicting any traffic control symbol, sequence of symbols, timer, animation, or other traffic control display. For example, the visual vehicular traffic control devices 142(1) may be configured to display a timer countdown indicating time to change of states. Furthermore, the visual vehicular traffic control devices 142(1) may be configured to display an animation of a particular traffic control sequence. Other forms of states and state changes are also applicable depending upon any particular implementation, and are within the scope of this disclosure.

Non-visual vehicular traffic control devices can include several physical devices configured to physically alter the flow of or control vehicular traffic. For example, non-visual vehicular traffic control devices can include doors and gateways configured to allow vehicular traffic to enter or exit particular portions of a roadway or traffic infrastructure. Non-visual vehicular traffic control devices can also include physical barriers that can move to allow uni-directional or bi-directional access to specified portions of roadways or traffic infrastructure such as bridges, toll roads, and the like. Other non-visual traffic control devices are also contemplated, and are within the scope of this disclosure. Traffic devices can also include vehicles, such as an autonomous vehicle that is controlled by the system 100. In such configurations, vehicles that are controlled by the system 100, can influence the flow of traffic. In some embodiments, the system 100 or some vehicles can send control data to an autonomous vehicle. The control data can be received and processed by the autonomous vehicle to control the speed and/or the direction of the vehicle. In some configurations, the control data can comprise directions or instructions to be displayed on a graphical user interface within the vehicle for guiding a driver to manually change the speed and/or the direction of the vehicle based on the control data.

Although a graphical user interface for displaying data is used as examples in the present disclosure, such example should not be construed as limiting. In some configurations, any data, such as the control data, can be communicated to a user via any suitable mechanism. For instance, an automated voice comprising the directions can be communicated to the user via a speaker system, a tactile system, etc.

Furthermore, it is contemplated that several combinations of visual and non-visual traffic control devices are also applicable. For example, some physical barriers may include visual indicators to aid drivers in traversing traffic. In other aspects, some physical gateways and toll access gates may include electronic lights, signage, and other similar visual aids. All such combinations are within the scope of this disclosure. Accordingly, the term “traffic control device” refers to both visual and non-visual traffic control devices, as well as combinations of visual and non-visual traffic control devices.

As further illustrated in FIG. 1, the system 100 also includes imaging devices 144(1) through 144(2) in communication with the traffic control server 101. The imaging devices 144(1) through 144(2) can include traffic cameras, digital cameras, infrared cameras, UV cameras, and other imaging apparatuses configured to capture images of vehicles, occupants, and other objects in their visual path. The imaging devices 144(1) through 144(2) may capture images of indicia indicating identifiers and other identifying information that is decipherable by the traffic control server 101 and priority processing module 112. For example, the imaging devices 144(1) through 144(2) may be configured to capture and decipher specific indicia or paint schemes, symbols (e.g., on a roof or upper surface of a vehicle), vehicle license plates, vehicle identification numbers, bar codes, matrix bar codes, or other identifying information.

Thus, the system 100 facilitates automated control of traffic devices, such as visual and non-visual traffic control devices 142(1) through 142(2), through the use of imaging devices 144(1) through 144(2), wireless communications components 140, and communications with the organizational data store 120 and vehicle identification data store 124. The traffic control server 101 can receive priority data 122, vehicle identifier data 126, and utilize the same to control states of the traffic control devices 142(1) through 142(2) such that efficient use of roadways by vehicles 130(1), 130(2) through 130(N) is facilitated.

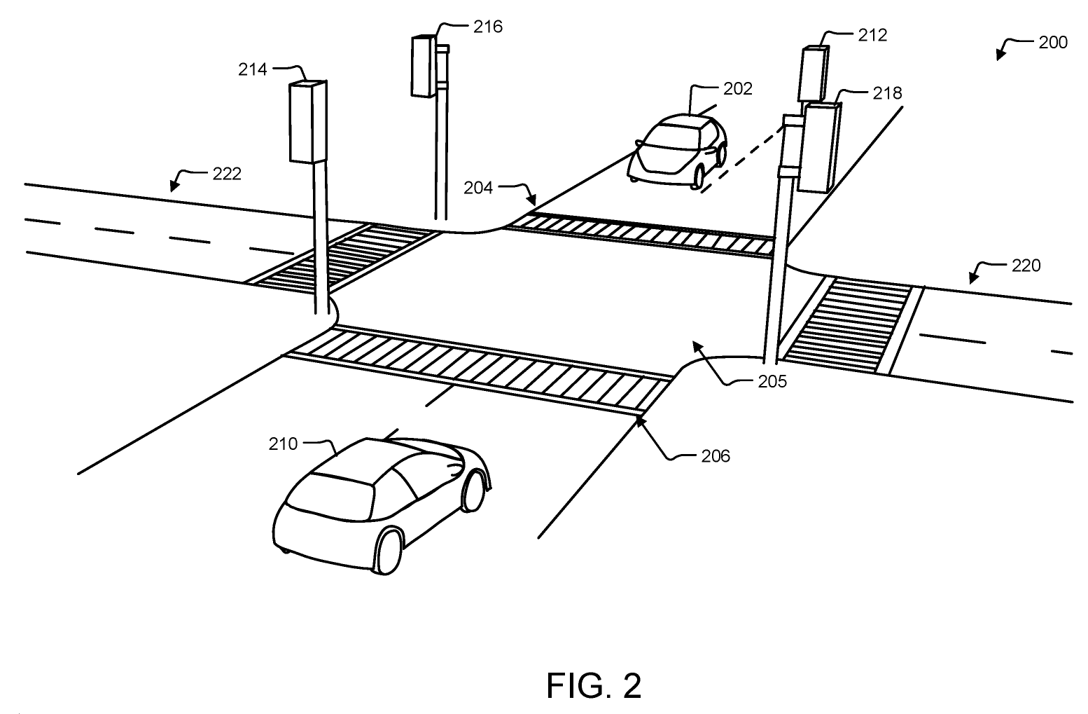

Turning now to FIG. 2, a more detailed discussion of the operation of the system 100 with regard to different forms of vehicles and vehicle/occupant priority is provided. More specifically, FIG. 2 is a diagram illustrating an example scenario 200 in which one or more vehicles approach an automated traffic intersection.

As shown in FIG. 2, vehicle 202 is approaching intersection 205. Furthermore, traffic associated with the intersection 205 is controlled via traffic control devices 212, 214, 216, and 218. Traffic control devices 212, 214, 216, and 218 are traffic lights in this example, and can be embodied as typical three-light panels containing red, yellow, and green lights. The vehicle 202 may be an autonomous vehicle, and may have transmitted or otherwise provided its vehicle ID 126 to an associated traffic control server 101 in this scenario. The vehicle 202 may also be a non-autonomous vehicle or an autonomous vehicle capable of being identified by a passive mechanism and/or an active mechanism, which may involve transmitting an identifier or otherwise providing its vehicle ID 126. As the vehicle 202 approaches the intersection 205 and the pedestrian crosswalk threshold 204, the traffic control server 101 may attempt to determine if lower priority traffic is flowing on intersecting roadways 220 or 222. Additionally, the traffic control server 101 may detect or otherwise determine that an additional vehicle 210 is travelling in the opposite direction towards the intersection 205 and the pedestrian crosswalk threshold 206.

In this scenario, the traffic control server 101 may direct the traffic control devices to allow the continued travel of the vehicle 202 through the intersection 205. The traffic control server 101 may facilitate this outcome by controlling the respective states of the traffic control devices 212, 214, 216 and 218 to impede the flow of traffic through the intersection 205 until the vehicle 202 has successfully traversed the intersection. For example, the traffic control server 101 may direct the traffic control devices 214, 216, and 218 to display a “red light” or stop indicia to vehicle 210 or any vehicles travelling on roadways 220 or 222.

In an alternative scenario, if the vehicle 210 is a vehicle with higher priority, e.g., having an occupant with a higher priority, than the vehicle 202, the traffic control server 101 may direct the traffic control devices 212, 216 and 218 to allow the continued travel of the vehicle 210 through the intersection on its intended route. The traffic control server 101 may facilitate this alternative outcome by controlling the respective states of the traffic control devices 212, 216 and 218 from the other three roadways represented until the vehicle 210 has successfully traversed the intersection. For example, the traffic control server may direct the traffic control devices 212, 216, and 218 to display a “red light” or other stop indicia.

As shown, the traffic control server 101 may determine respective priorities of more than one vehicle to facilitate an appropriate flow of traffic.

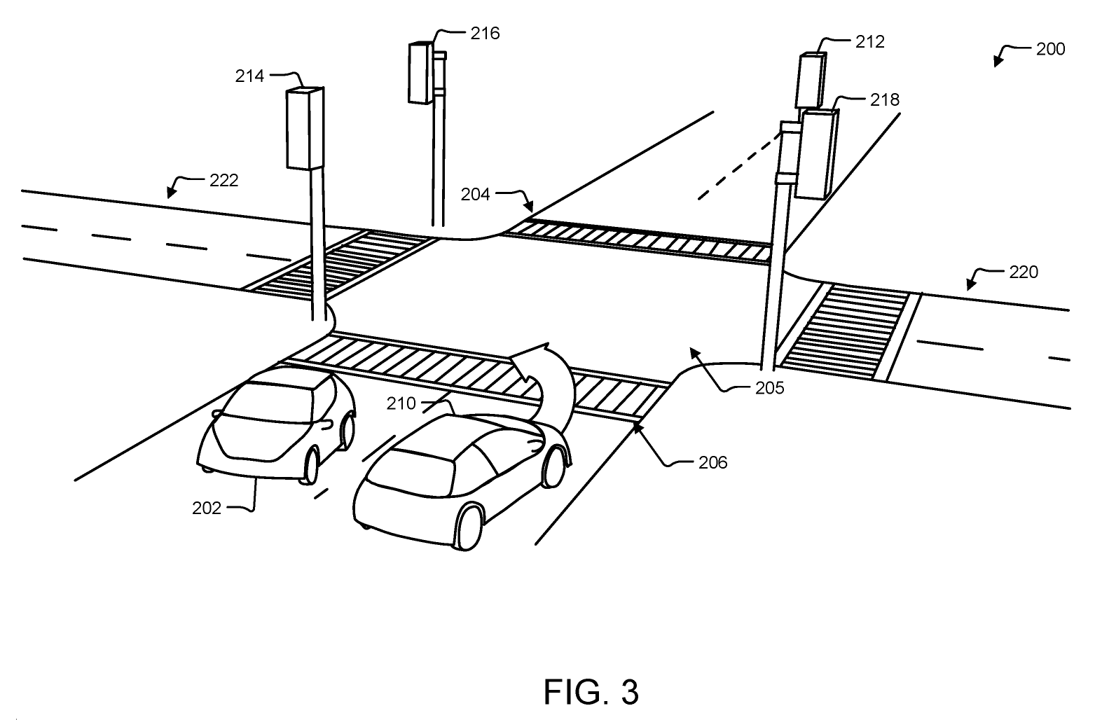

Turning now to FIG. 3, an example scenario 300 is illustrated in which one or more vehicles negotiate an automated intersection. As shown in FIG. 3, the vehicle 202 has successfully traversed the intersection 205, and is beyond a threshold distance from the intersection to allow safe travel of other vehicles through the intersection. In this example, the vehicle 210 may now negotiate a left turn onto roadway 222 through intersection 205 based on traffic control devices 212, 214, 216, and 218 depicting appropriate control states.

Thus, as described above, the traffic control server 101 may identify vehicles, determine vehicle priorities, and direct various traffic control devices to change states to facilitate an appropriate flow of traffic through an intersection. Hereinafter, additional details regarding other scenarios are provided to aid in understanding other aspects of this disclosure.

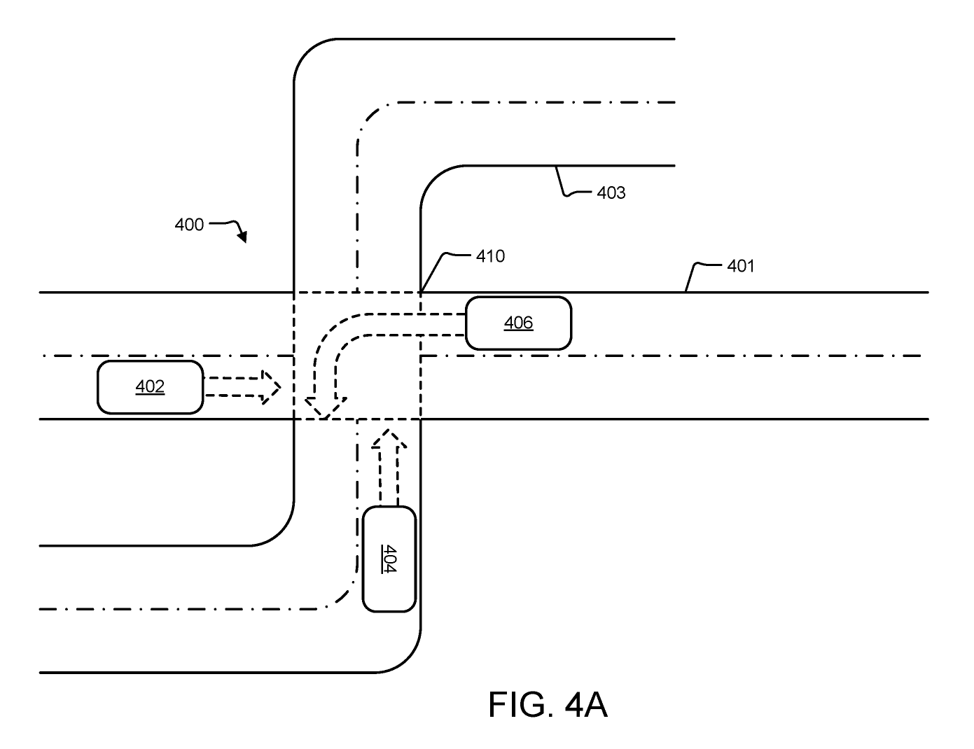

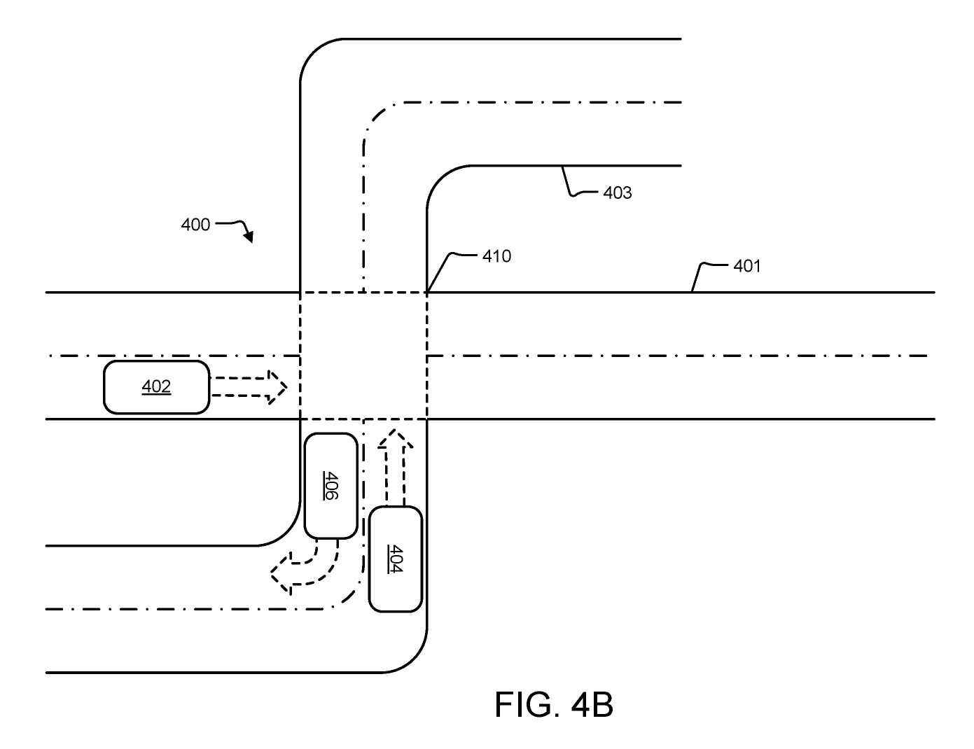

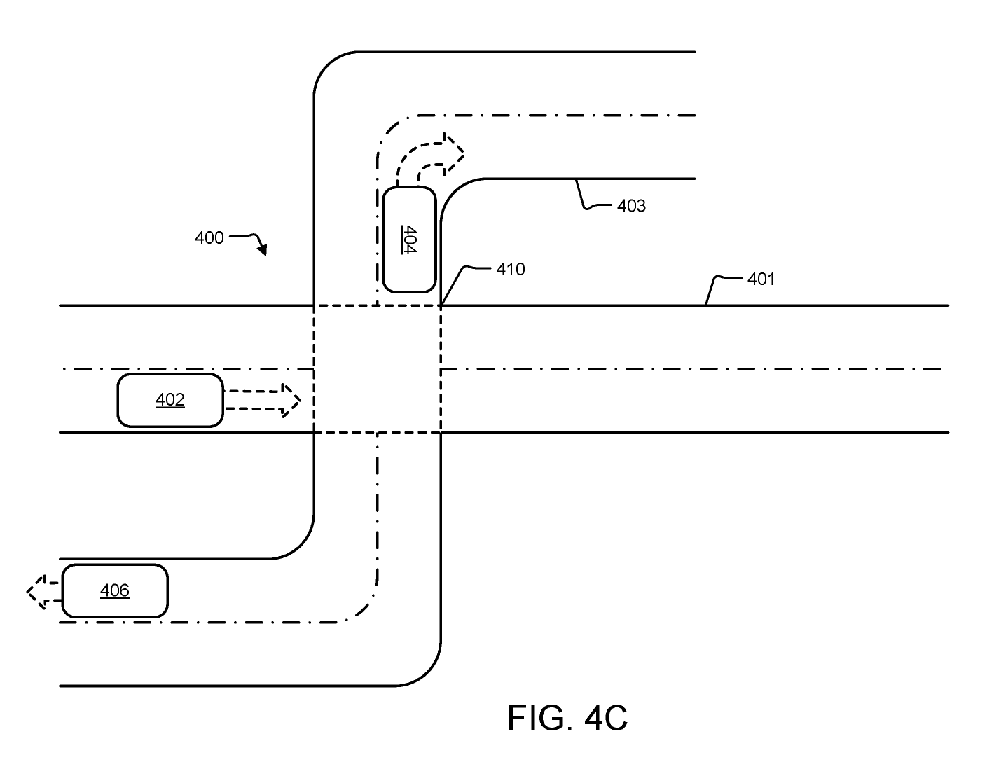

FIG. 4A is an overhead view of an example scenario in which one or more vehicles negotiate an automated intersection 400. In this scenario, the intersection 400 is the intersection of roadways 401 and 403. Additionally, vehicles 402, 404, and 406 are attempting to negotiate the intersection 400 based on a plurality of traffic control devices 410 controlling the flow of traffic through the intersection 400.

As shown, the vehicle 402 is attempting to directly traverse the intersection 400. Furthermore, the vehicle 404 is attempting to directly traverse the intersection. Finally, the vehicle 406 is attempting to traverse the intersection 400 and make a left-hand turn from roadway 401 to roadway 403.

In this particular example, the traffic control server 101 may identify each vehicle 402, 404, and 406. Furthermore, the traffic control server 101 may determine a priority associated with each vehicle 402, 404, and 406. For example, the highest priority vehicle may be given priority to traverse the intersection first, the second-highest priority vehicle to traverse second, and the third-highest priority vehicles to traverse last. As described above, the identification of each vehicle may be facilitated through camera imaging, direct communication, or otherwise. Additionally, the priority associated with each vehicle may be determined based on organizational data such as organizational hierarchy, calendar information, and other similar data. Furthermore, this scenario can utilize any type of priority data described herein.

FIG. 4B is an overhead view of an example scenario in which a vehicle is given priority over other vehicles to negotiate an intersection. As shown, the vehicle 406 was given higher priority to traverse the intersection 400. In this scenario, the vehicles 402 and 404 have successfully waited until the vehicle 406 traversed the intersection 400 and made a left-hand turn. Accordingly, the traffic control server 101 may now control the states of the plurality of traffic control devices 410 to allow the vehicles 404 and 402 to continue on their respective routes based on an additional comparison of priority. It is noted that if an additional vehicle approached the intersection 400 (not illustrated), further calculations of priority, timing, and otherwise may be appropriate. Furthermore, this scenario can utilize any type of priority data described herein.

FIG. 4C is an overhead view of an example scenario in which a vehicle is given priority over another vehicle to negotiate an intersection. As shown, the traffic control server 101 has determined that the vehicle 402 was unable to establish a priority higher than the vehicle 404. Accordingly, the traffic control server 101 has directed the states of the plurality of traffic control devices 410 to allow the vehicle 404 to traverse the intersection while the vehicle 402 must remain stopped. As further illustrated, the travel of vehicle 406 was unimpeded due to it having already exited the intersection 400. It is noted that had a higher priority been established for the vehicle 402, the alternative scenario where the vehicle 402 traversed the intersection first would be appropriate. Furthermore, this scenario can utilize any type of priority data described herein to establish appropriate control of the plurality of traffic control devices 410.

Thus, as described above, the traffic control server 101 may identify several vehicles, determine vehicle priorities and whether vehicles are autonomously controlled, and direct a plurality of traffic control devices to change states to facilitate an appropriate flow of traffic through an intersection. Hereinafter, additional details regarding other scenarios are provided to aid in understanding other aspects of this disclosure.

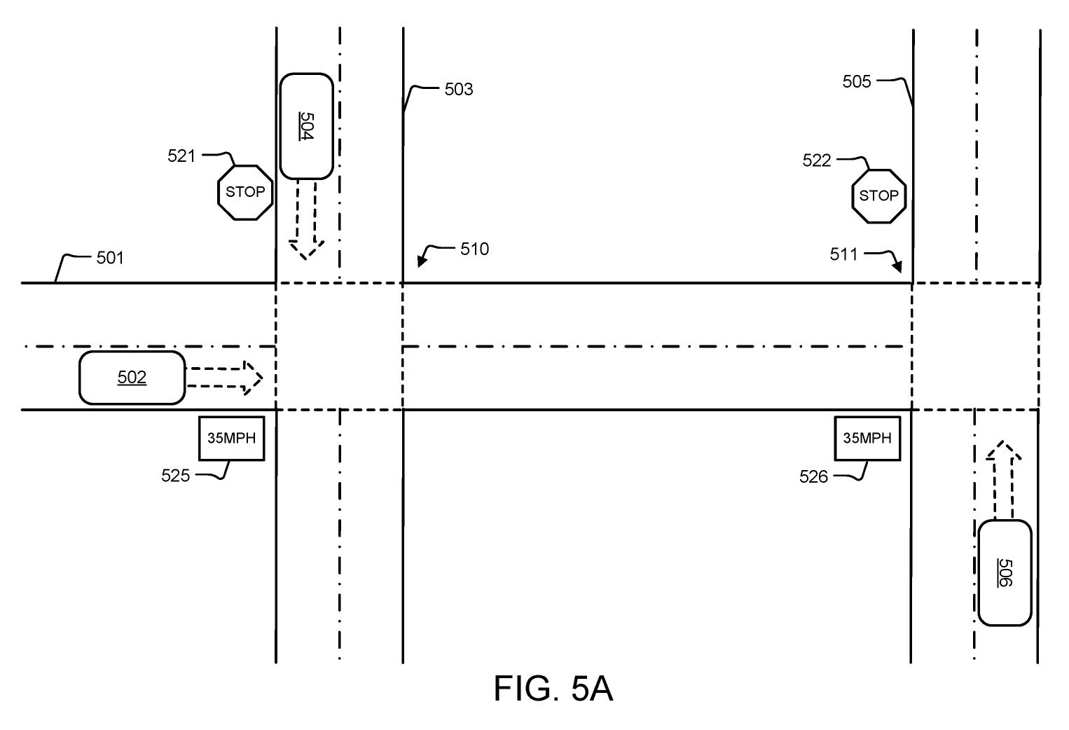

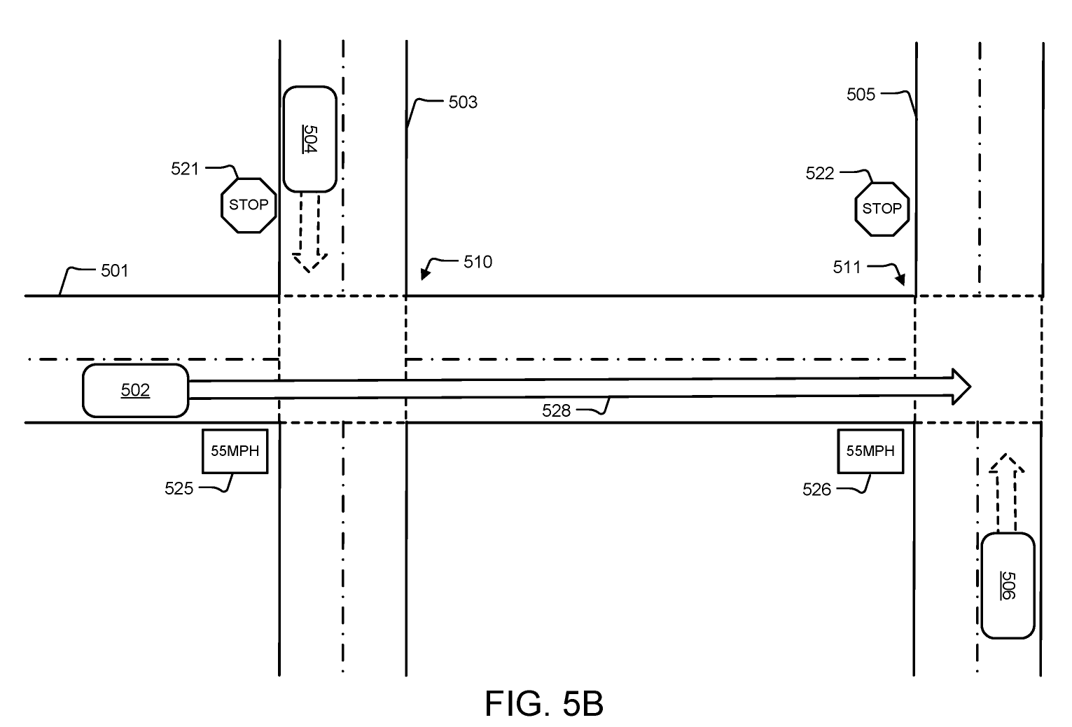

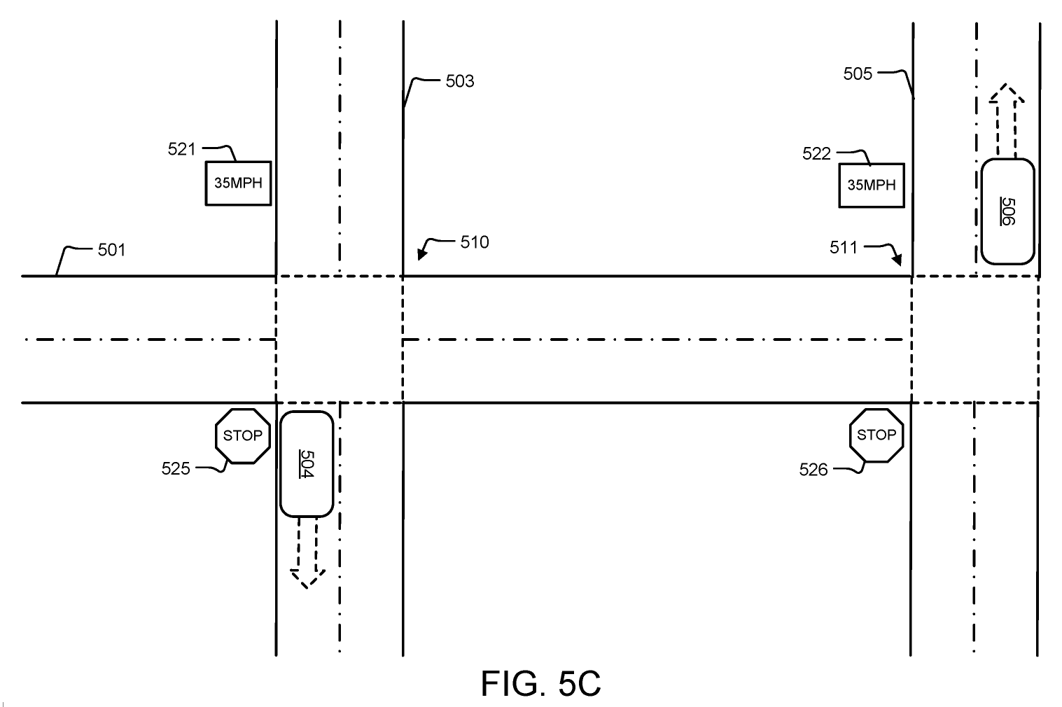

FIG. 5A is an overhead view of an example scenario in which one or more vehicles negotiate different intersections. In this scenario, the intersection 510 includes at least traffic control devices 521 and 525, and is the intersection of roadways 501 and 503. Additionally, the intersection 511 includes at least traffic control devices 522 and 526, and is the intersection of roadways 501 and 505. Furthermore, vehicle 502 is approaching intersection 510 and has transmitted routing information to the traffic control server 101 indicating a route of travel straight through both intersections 510 and 511 directly. Vehicles 504 and 506 are also approaching intersections 510 and 511, respectively. In this example, the traffic control server 101 may identify each vehicle and determine that the vehicle 502 has a higher priority due to a scheduled meeting and an organizational hierarchy indicating a high priority necessity for an occupant of vehicle 502 to reach a destination beyond the intersection 511. Furthermore, the traffic control server 101 has determined that both vehicles 504 and 506 have positions on the same organizational hierarchy lower than the occupants of vehicle 502. It is noted that the traffic control devices 521 and 522 initially denote a maximum speed limit of 35 miles per hour. Accordingly, one appropriate response by the traffic control server 101 may be to maintain the traffic control signals 521 and 522 in a STOP state, while allowing the vehicle 502 to travel at less than or equal to 35 miles per hour until it successfully traverses each intersection. Alternatively, the traffic control server may determine that an increase in the speed limit may be more efficient, as explained below.

FIG. 5B is an overhead view of an example scenario in which a vehicle is given a prioritized route over other vehicles. In this scenario, the traffic control server 101 has identified each vehicle and determined that the vehicle 502 has a higher priority due to a scheduled meeting and an organizational hierarchy indicating a high priority necessity for an occupant of vehicle 502 to reach a destination beyond the intersection 511 relatively quickly. Accordingly, the traffic control server has determined that the route 528 of the vehicle 502 requires an increase in the speed limit in order to safely allow traffic to flow efficiently while allowing each vehicle to reach its respective destination on time. Thus, the traffic control server 101 has directed the traffic control devices 521 and 522 to indicate in increase in the speed limit from 35 miles per hour to 55 miles per hour, and has maintained the STOP states of the traffic control devices 525 and 526. Thus, the vehicle 502 may quickly travel the prioritized route 528.

FIG. 5C is an overhead view of an example scenario in which vehicles are directed to cross a previously prioritized route. As described above, the prioritized route 528 crossed over intersections 510 and 511. In this scenario, the vehicle 502 (not shown in FIG. 5C) has successfully traversed the prioritized route 528. Subsequently, the traffic control server 101 has directed the traffic control devices 525 and 526 to STOP states ceasing the flow of traffic on the roadway 501, while allowing vehicles 504 and 506 to travel at approximately 35 miles per hour on roadways 503 and 505 through appropriate indications on traffic control devices 521 and 522, respectively.

It is noted that as illustrated in FIG. 5A, FIG. 5B, and FIG. 5C, traffic control devices 521, 522, 525, and 526 are implemented as electronic signs capable of displaying a variety of traffic control data in different states. As such, each traffic control device 521, 522, 525, and 526 is individually capable of displaying a plurality of representations of typical traffic control signs in a graphical manner, thereby reproducing a STOP sign, YIELD sign, speed limit posting sign, and any other traffic control sign. Other variations are also applicable according to any desired implementation. Furthermore, the illustrated scenarios can utilize any type of priority data described herein in determining appropriate states for the traffic control devices 521, 522, 525, and 526.

Thus, as described above, system 100 including the traffic control server 101 may facilitate automated control of vehicular traffic devices with vehicles. The traffic control server 101 may identify vehicles, determine vehicle priorities, and direct various traffic control devices to change states to facilitate an appropriate flow of traffic on a plurality of different roadways. Additionally, prioritized routes may be established, speed limits may be increased or decreased, and other traffic control services can be provided. It should be understood that although illustrated as including visual traffic control devices, other non-visual traffic control devices are also possible and are contemplated, as well as combinations of visual and non-visual traffic control devices.

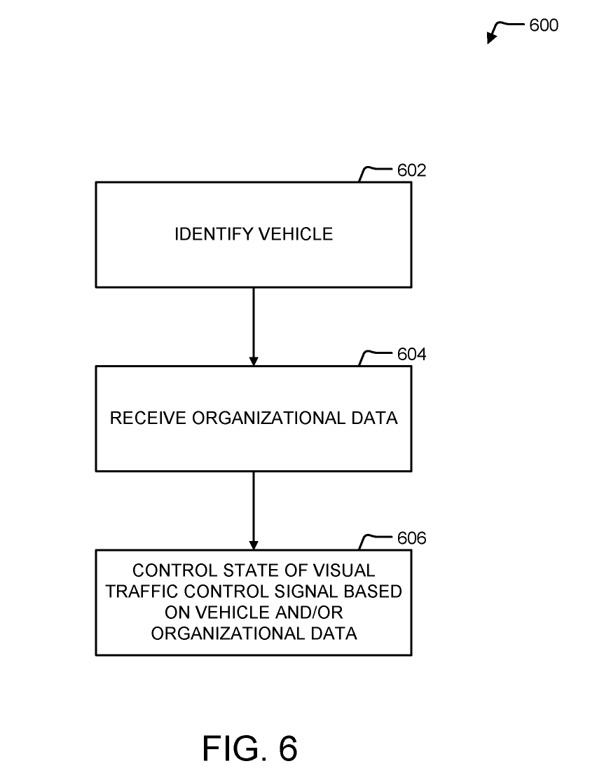

Hereinafter, a more detailed discussion of the operation of the systems and components described above is provided with reference to several flow diagrams. As illustrated in FIG. 6, aspects of the method 600 for automated control of traffic devices are shown and described. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented in various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the method 600 are described herein as being implemented, at least in part, by system components, which can comprise an application, component and/or a circuit. In some configurations, the system components include a dynamically linked library (DLL), a statically linked library, functionality produced by an application programming interface (API), a compiled program, an interpreted program, a script or any other executable set of instructions. Data, such as the priority data 122, vehicle ID 126, and other data, can be stored in a data structure in one or more memory components. Data can be retrieved from the data structure by addressing links or references to the data structure.

Although the following illustration refers to the components of FIG. 1, it can be appreciated that the operations of the method 600 may be also implemented in many other ways. For example, the method 600 may be implemented, at least in part, by a processor of another remote computer or a local circuit. In addition, one or more of the operations of the method 600 may alternatively or additionally be implemented, at least in part, by a chipset working alone or in conjunction with other software modules. Any service, circuit or application suitable for providing the techniques disclosed herein can be used in operations described herein.

FIG. 6 is a flow diagram of a method of automated control of traffic devices with vehicles, according to the techniques and technologies disclosed herein. For example, the method 600 can be performed by the traffic control server 101 and/or the priority processing module 112, in some implementations. As shown, the traffic control server 101 identifies a vehicle by at least one vehicle identifier, at block 602.

Generally, the identification can include visually identifying the vehicle with a set of indicia visible upon the vehicle. For example, the indicia may represent a vehicle identification number (VIN), a license plate identification number, a traffic service registration number, and/or a vehicle profile identification number. Furthermore, the identification can include receiving, by the traffic control server 101, the vehicle identifier directly or indirectly from the vehicle. For example, the vehicle may wirelessly transmit the vehicle identifier to the traffic control server via a wireless signal through the wireless communications components 140. Other forms of identification may also be applicable.

Upon identifying the vehicle, the traffic control server 101 may receive organizational data indicating a priority level associated with a user identity, at block 604. Generally, the user identity is associated with an occupant of the vehicle. Furthermore, the organizational data can include an organizational chart or organizational mapping data indicating the priority level. According to at least one implementation, the organizational data includes private enterprise organizational data or government organizational data.

Thereafter, the traffic control server 101 can control a state of a visual traffic control signal based on the priority level, at block 606. The state of the visual traffic control signal can control vehicular traffic flow around or about the vehicle. For example, the traffic control server 101 can cause the visual traffic control signal to change from a first state to a second state. The traffic control server 101 can also cause the visual traffic control signal to change from the second state to a third state.

Through directing the changing of the states of the traffic control devices and signals, the traffic control server 101 can direct vehicular traffic and increase traffic efficiency in real time. The traffic control server 101 can also take into consideration vehicle locations, vehicle speeds and routing information to further increase traffic efficiency.

For example, the traffic control server 101 can detect a location of the vehicle responsive to controlling the state of the visual traffic control signal, and, responsive to detecting that the vehicle is beyond a threshold distance from the visual traffic control signal, cause the visual traffic control signal to change from the third state to the first state. In this manner, the traffic control server can quickly change the states of traffic control signals and devices as opposed to timer-based logic in conventional traffic systems.

In some instances, the traffic control server 101 may also need to determine priorities of approaching vehicles, for example as depicted in FIG. 2. In this instance, the traffic control server 101 may detect that an identified vehicle is travelling towards the visual traffic control signal within a threshold distance, and in response to the detection, requests the organizational data from a data store, such as data store 120 or from the vehicle itself.

Thus, as described above, the traffic control server 101 may operate to quickly and efficiently direct traffic of vehicles utilizing a plurality of traffic control devices such as traffic control signals. The traffic control server may process organizational data and vehicle identifiers to determine occupant priority, and may also establish prioritized routes for some vehicles. It is understood that many of these features and aspects may be used in different combinations depending upon any real-world scenario. Accordingly, this disclosure should not be limited to the scenarios illustrated, but should extend to all forms of automated traffic control device control using various vehicles.

In addition to the benefits of the examples disclosed above, the techniques disclosed herein can also provide a number of other benefits. For example, a system can make a determination on a traffic control signal based on a physical characteristic of a vehicle or a group of vehicles. For example, a system can consider the length of a vehicle or a group of vehicles for allowing the traffic signals to stay green, or in a particular state, sufficiently long enough for a long vehicle or a set number of vehicles to pass through.

Information about the vehicle could be used to determine the priority with which it receives a green light. For example, vehicles with multiple passengers (“car pool”), emergency vehicles, or public transit could receive priority.

Vehicle owners could also pay for prioritized access to the green light, either through a set fee or auction system, or by using a credit based system. This could be set up ahead of schedule or once the vehicle reaches a particular intersection. It is also feasible to implement a system where fees get cheaper in accordance with the number of people in a lane who participate.

Speed limits and other signage could be adapted based on the characteristics of a vehicle. For example, vehicles with a high safety rating, good quality brakes, or full automation support could be allowed to travel faster. Similarly, if only automated cars are approaching an intersection, traffic signals or stop signs could be switched to a special mode allowing all cars to drive through at full speed, provided the automation in all vehicles is capable of maintaining distances in accordance with safety regulations.

Traffic light priority, speed limits, and other signals could also be modified based on the behavior of the vehicle, e.g., either the specific vehicle or that make and model. For example, vehicles with a good history of decision making in difficult circumstances or a good environmental record could be rewarded. This could also be based off service history, with vehicles registered as having been recently serviced by an authorized agent given priority.

The metadata provided to traffic controls can also be aggregated centrally or locally for various purposes such as traffic flow analysis, road improvement considerations and vehicle tracking, e.g., by police, etc.

When the destination of the authenticating vehicle is known, or inferred from data indicating locations such as meeting destinations in a calendar system, traffic signs can be changed to direct other vehicles to other roads to clear up following streets and allowing for shorter travel durations of the authenticating vehicle. For example, calendar data can include a description of a meeting at a particular location. Such a location can indicate a destination for a vehicle. As a vehicle navigates to the destination, a navigation system in a vehicle, such as a GPS system in vehicle or a phone within the vehicle, can provide real-time location data for the vehicle for coordination with one or more traffic devices. As the vehicle moves through a route, the system 100 can monitor the vehicle's location in real-time and change the state of one or more traffic devices according the techniques disclosed herein. For example, traffic signs, signals, or any other traffic device can be changed to direct other vehicles to other roads to clear up following streets and allowing for shorter travel durations of the authenticating vehicle.

FIG. 7 shows additional details of an example computer architecture for the components shown in FIG. 1 capable of executing the program components described above. The computer architecture shown in FIG. 7 illustrates aspects of a system, such as an autonomous vehicle control system or computer system, and may be utilized to execute any of the software components presented herein. For example, the computer architecture shown in FIG. 7 may be utilized to execute any of the software components described above. Although some of the components described herein are specific to the vehicle 130 and/or traffic control server 101, it can be appreciated that such components, as well as other components, may be part of any suitable remote computer. In another example, the organizational data store 120 and vehicle identification data store 124 can include the depicted computer architecture or such stores can be, at least in part, part of a remote service.

It should be understood that although described as an autonomous vehicle, traffic control server, and/or computer, the device 731 (also referred to herein as a “computing system”) can take many forms. The device 731 includes a baseboard 702, or “motherboard,” which is a printed circuit board to which a multitude of components or devices may be connected by way of a system bus or other electrical communication paths. In one illustrative embodiment, one or more central processing units (“CPUs”) 704 operate in conjunction with a bus 706. According to at least one implementation, the bus 706 may be implemented as a chip set. The CPUs 704 may be standard programmable processors that perform arithmetic and logical operations necessary for the operation of the device 731.

The CPUs 704 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The bus 706 provides an interface between the CPUs 704 and the remainder of the components and devices on the baseboard 702. The bus 706 may provide an interface to a RAM 708, used as the main memory in the device 731. The bus 706 may further provide an interface to a computer-readable storage medium such as a read-only memory (“ROM”) 710 or non-volatile RAM (“NVRAM”) for storing basic routines that help to start up the device 731 and to transfer information between the various components and devices. The ROM 710 or NVRAM may also store other software components necessary for the operation of the device 731 in accordance with the embodiments described herein.

The device 731 may operate in a networked environment using logical connections to remote computing devices and computer systems through a network 714, such as the local area network. The bus 706 may include functionality for providing network connectivity through a network interface controller (NIC) 712, such as a gigabit Ethernet adapter. The NIC 712 is capable of connecting the device 731 to other computing devices over the network. It should be appreciated that multiple NICs 712 may be present in the device 731, connecting the computer to other types of networks and remote computer systems. The network allows the device 731 to communicate with remote services and servers, such as the remote computer 701. As can be appreciated, the remote computer 701 may host a number of services such as traffic control services, weather information services, emergency vehicle location services, and other services. In addition, as described above, the remote computer 701 may mirror and reflect data stored on the device 731 and host services that may provide data or processing for the techniques described herein.

The device 731 may be connected to a mass storage device 726 that provides non-volatile storage for the computing device. The mass storage device 726 may store system programs, application programs, other program modules, and data, which have been described in greater detail herein. The mass storage device 726 may be connected to the device 731 through a storage controller 715 connected to the bus 706. The mass storage device 726 may consist of one or more physical storage units. The storage controller 715 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. It should also be appreciated that the mass storage device 726, other storage media and the storage controller 715 may include MultiMediaCard (MMC) components, eMMC components, Secure Digital (SD) components, PCI Express components, or the like.

The device 731 may store data on the mass storage device 726 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 726 is characterized as primary or secondary storage, and the like.

For example, the device 731 may store information to the mass storage device 726 by issuing instructions through the storage controller 715 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The device 731 may further read information from the mass storage device 726 by detecting the physical states or characteristics of one or more particular locations within the physical storage units.

In addition to the mass storage device 726 described above, the device 731 may have access to other computer-readable media to store and retrieve information, such as program modules, data structures, or other data. Thus, while the autonomous driving application 729, other data and other modules are depicted as data and software stored in the mass storage device 726, it should be appreciated that these components and/or other modules may be stored, at least in part, in other computer-readable storage media of the device 731. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the device 731.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the device 731. For purposes of the claims, the phrase “computer storage medium,” “computer-readable storage medium,” and variations thereof, does not include waves or signals per se and/or communication media.

The mass storage device 726 may store an operating system 727 utilized to control the operation of the device 731. According to one embodiment, the operating system comprises an autonomous vehicle operating system. According to another embodiment, the operating system comprises the WINDOWS® operating system from MICROSOFT Corporation. According to further embodiments, the operating system may comprise the UNIX, ANDROID, WINDOWS PHONE, MacOS, or iOS operating systems, available from their respective manufacturers. It should be appreciated that other operating systems may also be utilized. The mass storage device 726 may store other system or application programs and data utilized by the device 731, such as any of the other software components and data described above. The mass storage device 726 might also store other programs and data not specifically identified herein.

In one embodiment, the mass storage device 726 or other computer-readable storage media is encoded with computer-executable instructions which, when loaded into the device 731, transform the computer from a general-purpose computing system into a special-purpose computer capable of implementing the embodiments described herein. These computer-executable instructions transform the device 731 by specifying how the CPUs 704 transition between states, as described above. According to one embodiment, the device 731 has access to computer-readable storage media storing computer-executable instructions which, when executed by the device 731, perform the various routines described above with regard to FIG. 4 and the other FIGURES. The device 731 might also include computer-readable storage media for performing any of the other computer-implemented operations described herein.

The device 731 may also include one or more input/output controllers 716 for receiving and processing input from a number of input devices, such as a keyboard, a mouse, a microphone, a headset, a touchpad, a touch screen, an electronic stylus, a speed monitoring system, an engine/motor monitoring system, a vehicle monitoring system, or any other type of input device. Also shown, the input/output controller 716 is in communication with an input/output device 725. The input/output controller 716 may provide output to a display, such as a computer monitor, a flat-panel display, a digital projector, a printer, a plotter, or other type of output device. The input/output controller 716 may also provide output to an engine/motor control unit, variable frequency drive, drivetrain control system, vehicle control system, and any other output device for operating an autonomous vehicle. The input/output controller 716 may provide input communication with other devices such as a microphone, a speaker, steering controllers and/or audio devices. Furthermore, with respect to autonomous vehicular control, the device 731 may also include a positioning device, such as GPS 770, to receive positioning data or other data indicating location.

In addition, or alternatively, a video output 722 may be in communication with the bus 706 and operate independently from the input/output controllers 716. It will be appreciated that the device 731 may not include all of the components shown in FIG. 7, may include other components that are not explicitly shown in FIG. 7, or may utilize an architecture completely different than that shown in FIG. 7.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The present disclosure is made in light of the following examples:

### Example 1

A computer-implemented method, comprising: identifying (602) a vehicle (130) by at least one vehicle identifier (126), receiving (604) organizational data (122) indicating a priority level associated with a user identity, the user identity being associated with an occupant of the vehicle (130), wherein the organizational data defines a calendar event associated with the user identity, wherein the priority level is based on at least one of a category of the calendar event, a number of attendees of the calendar event, a role associated with the occupant, a length of time of the calendar event, or a rank of an attendee of the calendar event, and controlling (606) a state of a visual traffic control signal (142) based on the priority level, the state of the visual traffic control signal (142) controlling a flow of traffic around the vehicle (130).

### Example 2

The computer-implemented method as in example 1, wherein identifying the vehicle comprises: visually identifying the vehicle with a set of indicia visible upon the vehicle, and determining the priority level of the occupant of the vehicle based on the visual identification.

### Example 3

The computer-implemented method as in example 1, wherein the at least one vehicle identifier comprises at least one of: a vehicle identification number (VIN), a license plate identification number, a traffic service registration number, a vehicle digital identifier, and a vehicle profile identification number.

### Example 4

The computer-implemented method as in example 1, wherein the organizational data comprises: an organizational chart or organizational mapping data indicating the priority level.

### Example 5

The computer-implemented method as in example 1, wherein controlling the state of a visual traffic control signal comprises: causing the visual traffic control signal to change from a first state to a second state.

### Example 6

The computer-implemented method as in example 5, wherein controlling the state of a visual traffic control signal comprises: causing the visual traffic control signal to change from the second state to a third state.

### Example 7

The computer-implemented method as in example 6, further comprising: detecting a location of the vehicle responsive to controlling the state of the visual traffic control signal, and responsive to detecting that the vehicle is beyond a threshold distance from the visual traffic control signal, causing the visual traffic control signal to change from the third state to the first state.

### Example 8

The computer-implemented method as in example 1, further comprising: detecting that the identified vehicle is within a threshold distance from the visual traffic control signal and travelling towards the visual traffic control signal, and in response to the detection, requesting the organizational data from a data store.

### Example 9

The computer-implemented method as in example 1, further comprising: detecting that the identified vehicle is travelling towards and is within a threshold distance from the visual traffic control signal, and in response to the detection, requesting the organizational data from the vehicle.

### Example 10

The computer-implemented method as in example 1, wherein the visual traffic control signal is at least one of a vehicular traffic light, a right-of-way sign, a speed-limit posting sign, a yield sign, a stop sign, a traffic turn light, a flashing traffic control light, a railroad crossing signal, warning sign, and a toll device.

### Example 11

The computer-implemented method as in example 1, wherein controlling the state of the visual traffic control signal comprises: increasing or reducing a speed limit depicted on the visual traffic control signal based on the priority level.

### Example 12

The computer-implemented method as in example 1, wherein controlling the state of a visual traffic control signal comprises: increasing or reducing a speed limit depicted on the visual traffic control signal based on the at least one vehicle identifier.

### Example 13

The computer-implemented method as in example 1, wherein the organizational data comprises private enterprise organizational data, educational organizational data, or government organizational data.

### Example 14

The computer-implemented method as in example 1, wherein the organizational data comprises scheduling information indicative of at least one priority event.

### Example 15

A system of vehicular traffic control and routing, comprising: a first visual traffic control signal (142), a second visual traffic control signal (142), and, a traffic control server (101) in operative communication with the first visual traffic control signal (142) and the second visual traffic control signal (142), wherein the traffic control server is configured to perform a method, comprising: identifying (602) a vehicle (130) by at least one vehicle identifier (126), receiving (604) organizational data indicating a priority level associated with a user identity, the user identity being associated with an occupant of the vehicle, wherein the organizational data defines a calendar event having one or more attributes, wherein the calendar event is associated with the user identity, and wherein the priority level is based on the one or more attributes, controlling (606) a state of the first visual traffic control signal (142) based on the priority level, the state of the first visual traffic control signal controlling a flow of traffic with the vehicle (130), and controlling (606) a state of the second visual traffic control signal (142) based on the priority level, the state of the second visual traffic control signal stopping an opposing flow of traffic about the vehicle (130).

### Example 16

The system as in example 15, wherein identifying the vehicle comprises: visually identifying the vehicle with a set of indicia visible upon the vehicle, and determining the priority level of the occupant of the vehicle based on the visual identification.

### Example 17

The system as in example 15, wherein the at least one vehicle identifier comprises at least one of: a vehicle identification number (VIN), a license plate identification number, a traffic service registration number, and a vehicle profile identification number.

### Example 18

The system as in example 15, wherein the one or more attributes comprise at least one of: a category of the calendar event, a number of attendees of the calendar event, a role associated with the occupant, a length of the calendar event, or a rank of an attendee of the calendar event.

### Example 19

A computer-implemented method, comprising: electronically identifying (602) a vehicle (130) by at least one vehicle identifier (126), receiving (604) organizational data (122) indicating a priority level associated with a user identity and an anticipated route for the vehicle (130), the user identity being associated with an occupant of the vehicle, wherein the organizational data defines a calendar event having one or more attributes, and wherein the priority level is based on the one or more attributes, and controlling (606) a state of at least one traffic control device (142) based on the priority level, the state of the at least one traffic control device (140) at least partially controlling a flow of traffic on the anticipated route.

### Example 20

The computer-implemented method as in example 19, further comprising: establishing a prioritized route for the vehicle based on the anticipated route, and controlling states of traffic control devices on the prioritized route to allow unimpeded travel of the prioritized vehicle.

1. A computer-implemented method, comprising:
identifying a vehicle by at least one vehicle identifier;
receiving organizational data indicating a priority level associated with a user identity, the user identity being associated with an occupant of the vehicle, wherein the organizational data defines a calendar event associated with the user identity, wherein the priority level is based on at least one of a category of the calendar event, a number of attendees of the calendar event, a role associated with the occupant, a length of time of the calendar event, or a rank of an attendee of the calendar event; and
controlling a state of a visual traffic control signal based on the priority level, the state of the visual traffic control signal controlling a flow of traffic around the vehicle.

2. The computer-implemented method of claim 1, wherein identifying the vehicle comprises:
visually identifying the vehicle with a set of indicia visible upon the vehicle; and
determining the priority level of the occupant of the vehicle based on the visual identification.

3. The computer-implemented method of claim 1, wherein the at least one vehicle identifier comprises at least one of:
a vehicle identification number (VIN), a license plate identification number, a traffic service registration number, a vehicle digital identifier, and a vehicle profile identification number.

4. The computer-implemented method of claim 1, wherein the organizational data comprises:
an organizational chart or organizational mapping data indicating the priority level.

5. The computer-implemented method of claim 1, wherein controlling the state of a visual traffic control signal comprises:
causing the visual traffic control signal to change from a first state to a second state.

6. The computer-implemented method of claim 5, wherein controlling the state of a visual traffic control signal comprises:
causing the visual traffic control signal to change from the second state to a third state.

7. The computer-implemented method of claim 6, further comprising:
detecting a location of the vehicle responsive to controlling the state of the visual traffic control signal; and
responsive to detecting that the vehicle is beyond a threshold distance from the visual traffic control signal, causing the visual traffic control signal to change from the third state to the first state.

8. The computer-implemented method of claim 1, further comprising:
detecting that the identified vehicle is within a threshold distance from the visual traffic control signal and travelling towards the visual traffic control signal; and
in response to the detection, requesting the organizational data from a data store.

9. The computer-implemented method of claim 1, further comprising:
detecting that the identified vehicle is travelling towards and is within a threshold distance from the visual traffic control signal; and
in response to the detection, requesting the organizational data from the vehicle.

10. The computer-implemented method of claim 1, wherein the visual traffic control signal is at least one of a vehicular traffic light, a right-of-way sign, a speed-limit posting sign, a yield sign, a stop sign, a traffic turn light, a flashing traffic control light, a railroad crossing signal, warning sign, and a toll device.

11. The computer-implemented method of claim 1, wherein controlling the state of the visual traffic control signal comprises:
increasing or reducing a speed limit depicted on the visual traffic control signal based on the priority level.

12. The computer-implemented method of claim 1, wherein controlling the state of a visual traffic control signal comprises:
increasing or reducing a speed limit depicted on the visual traffic control signal based on the at least one vehicle identifier.

13. The computer-implemented method of claim 1, wherein the organizational data comprises private enterprise organizational data, educational organizational data, or government organizational data.

14. The computer-implemented method of claim 1, wherein the organizational data comprises scheduling information indicative of at least one priority event.

15. A system of vehicular traffic control and routing, comprising:
a first visual traffic control signal;
a second visual traffic control signal; and,
a traffic control server in operative communication with the first visual traffic control signal and the second visual traffic control signal, wherein the traffic control server is configured to perform a method, comprising:
identifying a vehicle by at least one vehicle identifier,
receiving organizational data indicating a priority level associated with a user identity, the user identity being associated with an occupant of the vehicle, wherein the organizational data defines a calendar event having one or more attributes, wherein the calendar event is associated with the user identity, and wherein the priority level is based on the one or more attributes;
controlling a state of the first visual traffic control signal based on the priority level, the state of the first visual traffic control signal controlling a flow of traffic with the vehicle; and
controlling a state of the second visual traffic control signal based on the priority level, the state of the second visual traffic control signal stopping an opposing flow of traffic about the vehicle.

16. The system of claim 15, wherein identifying the vehicle comprises:
visually identifying the vehicle with a set of indicia visible upon the vehicle; and
determining the priority level of the occupant of the vehicle based on the visual identification.

17. The system of claim 15, wherein the at least one vehicle identifier comprises at least one of:
a vehicle identification number (VIN), a license plate identification number, a traffic service registration number, and a vehicle profile identification number.

18. The system of claim 15, wherein the one or more attributes comprise at least one of:
a category of the calendar event, a number of attendees of the calendar event, a role associated with the occupant, a length of the calendar event, or a rank of an attendee of the calendar event.

19. A computer-implemented method, comprising:
electronically identifying a vehicle by at least one vehicle identifier;
receiving organizational data indicating a priority level associated with a user identity and an anticipated route for the vehicle, the user identity being associated with an occupant of the vehicle, wherein the organizational data defines a calendar event having one or more attributes, and wherein the priority level is based on the one or more attributes; and
controlling a state of at least one traffic control device based on the priority level, the state of the at least one traffic control device at least partially controlling a flow of traffic on the anticipated route.

20. The computer-implemented method of claim 19, further comprising:
establishing a prioritized route for the vehicle based on the anticipated route; and
controlling states of traffic control devices on the prioritized route to allow unimpeded travel of the prioritized vehicle.
